(19) United States
(12) Patent Application Publication
(10) Pub. No.: US 2011/0058102 A1
(43) Pub. Date: Mar. 10, 2011

(54) VIDEO OUTPUT APPARATUS, AND VIDEO OUTPUT METHOD

(75) Inventor: Hayato NISHIMURA, Fukaya-shi (JP)

(73) Assignee: KABUSHIKI KAISHA TOSHIBA, Tokyo (JP)

(21) Appl. No.: 12/823,868

(22) Filed: Jun. 25, 2010

(30) Foreign Application Priority Data
Sep. 7, 2009 (JP) 2009-205742

(51) Int. Cl. H04N 5/445

(52) U.S. Cl. 348/564; 348/E05.104

(57) ABSTRACT

According to embodiments, there is provided a video output apparatus including: a receiving module configured to receive a plurality of video signals being different from one another; a video output module configured to output a multi-video screen in which a plurality of video presentation regions defined by dividing a screen with a given number are arranged on the same screen, the video presentation regions being displayed with videos corresponding to the received video signals; and a controller configured to control the video output module to output, upon receiving an instruction indicating the number of the video presentation regions to be displayed in the multi-video screen, an updated multi-video screen having the instructed number of the video presentation regions in a state where the multi-video screen is output.

### CROSS-REFERENCE TO RELATED APPLICATIONS

This application is based upon and claims the benefit of priority from Japanese Patent Application No. 2009-205742, filed on Sep. 7, 2009, the entire contents of which are incorporated herein by reference.

### BACKGROUND

1. Field

Embodiments described herein relate generally to a video output apparatus and a video output method which output plural program videos in a lump.

2. Description of the Related Art

In recent years, a large number of broadcasting programs have been broadcasted through various broadcasting networks, such as terrestrial digital broadcasting, satellite digital broadcasting, internet and CATV (Community Antenna Television). Moreover, the large number of broadcasting programs are individually broadcasted at the same time through the respective channels. A user of a program receivable apparatus can select any of the acquired broadcasting programs, and can perform viewing or picture recording.

When selecting any of the large number of broadcasting programs, thus, it is preferable for the user needs to select the program while simultaneously seeing videos of the acquired broadcasting programs.

For example, JP-2008-294912-A (FIG. 1, Paragraph [0037]) discloses the technique for simultaneously displaying, in a single screen, plural program videos received through a tuner for One-Seg (trademark) in terrestrial digital broadcasting and switching the selected program to be displayed in high definition which is received through a digital tuner.

Moreover, JP-H11-055592-A (FIG. 3, Paragraph [0030]) discloses the technique for presenting a multi-screen in which the number of display dividing screens is determined correspondingly with the number of receivable channels or the number of channels which are previously selected optionally.

In JP-2008-294912-A, plural program videos corresponding to the number of One-Seg tuners is displayed and a specific program is selected from the program videos to be displayed. However, the number of program images to be displayed or a layout has not been specially taken into consideration.

In JP-H11-055592-A, the number of display dividing screens is determined corresponding to the number of receivable channels or the number of channels which are previously selected optionally. Therefore, the degree of freedom of a user in the change of the number of the display dividing screens or the determination of the channel is restricted.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an example configuration of a TV receiver according to an embodiment.

FIG. 2 illustrates a remote controller provided with plural keys for inputting instruction, respectively.

FIG. 3 illustrates an example processing for displaying a multi-screen and for changing the number of video presenting regions in the multi-screen.

FIGS. 4A to 4D illustrate examples of the multi-screen.

FIGS. 5A to 5D illustrate example layouts of a main-video and a sub-video in each multi-screen illustrated in FIGS. 4A to 4D.

FIG. 6 illustrates example processings for operating the multi-screen.

FIGS. 7A to 7D illustrate examples of a focus movement over each multi-screen illustrated in FIGS. 4A to 4D.

FIGS. 8A to 8D illustrate the example cases where program related information is output in each multi-screen illustrated in FIGS. 4A to 4D.

FIGS. 9A to 9D illustrate the example cases where program explaining information is output in each multi-screen illustrated in FIGS. 4A to 4D.

### DETAILED DESCRIPTION

Various embodiments according to the present invention will be described hereinafter with reference to the accompanying drawings. In general, according to one embodiment of the present invention, there is provided a video output apparatus including: a receiving module configured to receive a plurality of video signals being different from one another; a video output module configured to output a multi-video screen in which a plurality of video presentation regions defined by dividing a screen with a given number are arranged on the same screen, the video presentation regions being displayed with videos corresponding to the received video signals; and a controller configured to control the video output module to output, upon receiving an instruction indicating the number of the video presentation regions to be displayed in the multi-video screen, an updated multi-video screen having the instructed number of the video presentation regions in a state where the multi-video screen is output.

An embodiment according to the invention will be described below with reference to the drawings.

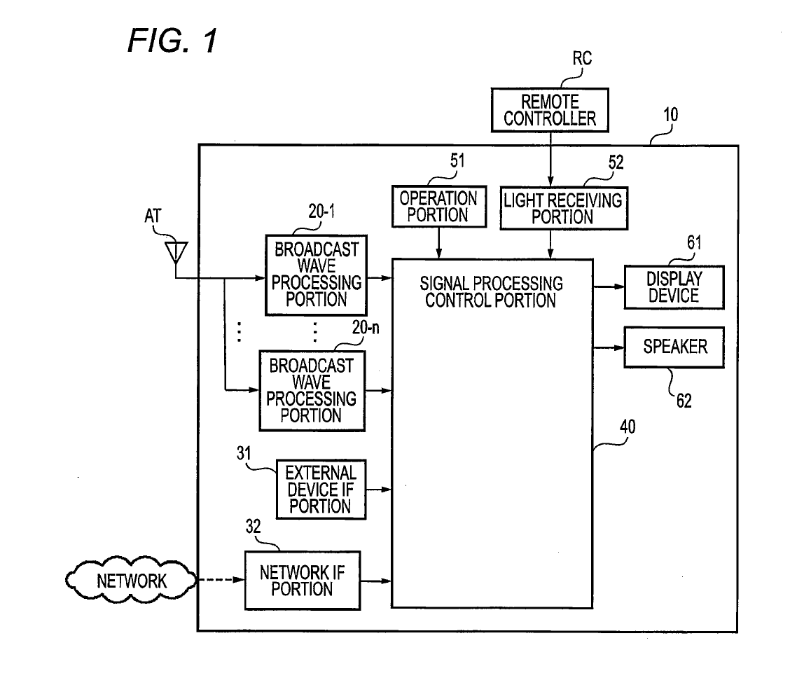

FIG. 1 illustrates the example configuration of a TV receiver 10 as a video output apparatus according to the embodiment. Although the TV receiver is exemplified, the embodiment can be applied to an HDD recorder, a DVD recorder, a personal computer or a portable moving terminal. Furthermore, the embodiment also can be applied to a set top box which is a video output apparatus for receiving wire broadcasting using radio broadcasting or Internet in addition to television broadcasting or satellite broadcasting.

The TV receiver 10 includes plural broadcast wave processing portions 20-1 to 20-n, an external device IF portion 31, a network IF portion 32, a signal processing control portion 40, an operation portion 51, a light receiving portion 52, a display device 61, and a speaker 62.

The TV receiver 10 acquires data of plural programs broadcasted through plural channels from the broadcast wave processing portions 20-1 to 20-n, the external device IF portion 31 or the network IF portion 32. The TV receiver 10 arranges videos of the acquired programs in a display screen of the display device 61 so that plural video presenting screens are presented in the same screen. The number of the video presenting regions to be displayed on the video presenting screens can be changed in accordance with an instruction of a user. The video presenting screens are also referred to as a multi-screen.

The broadcast wave processing portions 20-1 to 20-n have a tuner for acquiring a signal having a digital broadcast wave or an analog broadcast wave which is received through an antenna AT, and a decoder. The broadcast wave processing portions 20-1 to 20-n perform a channel selection processing and a demodulation/decode processing over the acquired signal and output, to the signal processing control portion 40, video/audio data of a program or data for generating an electronic program table (EPG).

For example, the TV receiver 10 includes eight tuners for a terrestrial digital broadcast wave. As well as the tuner for the terrestrial digital broadcast wave, there may be provided a tuner for a terrestrial analog broadcast wave, a tuner for a satellite digital broadcast wave, or a tuner for a satellite analog broadcast wave. For example, there may be provided eight tuners for a terrestrial digital broadcast wave, two tuners for a satellite digital broadcast wave, one tuner for a terrestrial analog broadcast wave and one tuner for a satellite analog broadcast wave, as the broadcast wave processing portions 20-1 to 20-n.

To the external device IF portion 31, an external device is connected to the TV receiver 10 based on a standard such as the USB standard or the IEEE1394 standard. Through the external device IF portion 31, video/audio data of a program and data for creating the EPG are received from the connected external apparatus such as a television broadcast wave receiving apparatus and transferred to the signal processing control portion 40. To the external device IF portion 31, a recording medium such as external HDD or a memory card may be connected based on the USB standard or the IEEE1394 standard, so that the video/audio data of the program are input/output to or from the connected recording medium.

The network IF portion 32 is provided to be connected to Internet or a network such as LAN or WAN and acquires video/audio data of a program broadcasted through the connected network or data for generating the EPG, and outputs them to the signal processing control portion 40. The network IF portion 32 is connected to the recording medium such as the external HDD or the memory card through the network, and outputs or inputs the video/audio data of the program to or from the connected recording medium.

The operation portion 51 receives instruction to operate the TV receiver 10 and outputs the same instruction to the signal processing control portion 40. Similarly, the light receiving portion 52 receives the user's instruction from a remote controller RC and outputs the same instruction to the signal processing control portion 40. The operation portion 51 or the remote controller RC includes a color key for directly changing the number of video presenting regions in a multi-screen and a direction key 213 for selecting a specific one of videos presented in the multi-screen.

The signal processing control portion 40 performs various processings such as a processing for decompressing data which are compressed and a data extraction processing for creating the EPG over a signal (data) input from the broadcast wave processing portions 20-1 to 20-n, the external device IF portion 31 or the network IF portion 32 based on the user's instruction from the operation portion 51 or the light receiving portion 52. Furthermore, the signal processing control portion 40 performs various processings such as an MPEG coding/decoding calculation processing and a processing for separating video and audio signals over the input signal (data), and outputs the video signal to the display device 61 and outputs the audio signal to the speaker 62. The signal processing control portion 40 includes a CPU and controls an execution of the processings by utilizing each module provided in the signal processing control portion 40 itself or each module connected to the signal processing control portion 40 itself.

In the embodiment, the signal processing control portion 40 performs a predetermined processing over each data of programs acquired from the broadcast wave processing portions 20-1 to 20-n, the external device IF portion 31 and the network IF portion 32, and generates a multi-screen in which the videos of the programs are presented in the same screen, and outputs the multi-screen to the display device 61. The signal processing control portion 40 generates an OSD screen for presenting program related information correspondingly with the videos of the respective programs to be displayed on the display device 61. The program related information includes a channel number, a broadcast wave, a name of a broadcasting station, and a program name of the respective program.

For example, the display device 61 is a display module for displaying the video signal input from the signal processing control portion 40 on a thin display panel such as an LCD (Liquid Crystal Display). The display device 61 displays the multi-screen in which the videos and the program related information of programs acquired from the broadcast wave processing portions 20-1 to 20-n, the external device IF portion 31 and the network IF portion 32 are presented in the same screen.

The speaker 62 outputs the audio signal input from the signal processing control portion 40.

By the embodiment configuration, the TV receiver 10 acquires the programs and displays, on the display device 61, the multi-screen in which the videos of the acquired programs are arranged in the video presenting regions of the display screen. The number of the video presenting regions can be changed. The processings are mainly executed by the signal processing control portion 40 based on the user's instruction from the operation portion 51 or the light receiving portion 52.

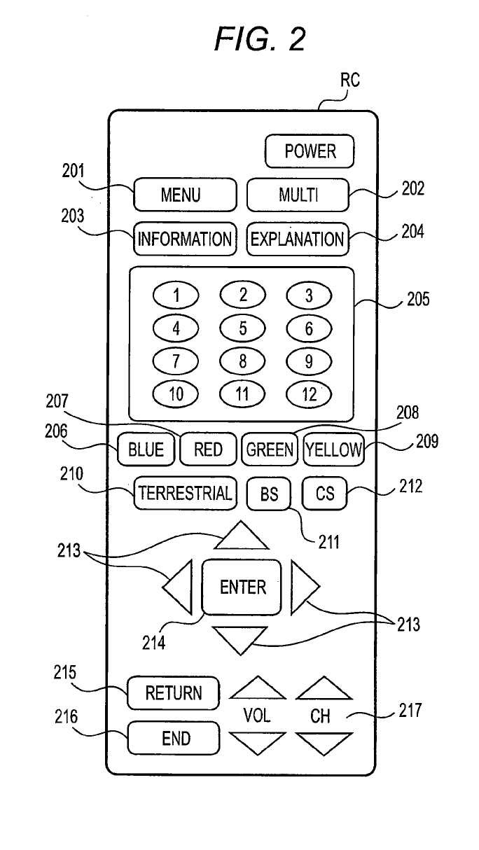

With reference to FIG. 2, next, explanation will be given to plural keys provided on the remote controller RC for transmitting the user's instruction to the light receiving portion 52 described with reference to FIG. 1.

FIG. 2 illustrates the remote controller RC provided with the keys for inputting instruction, respectively.

A user operates the TV receiver 10 by pressing down a specific one of the keys provided on the remote controller RC to output the instruction corresponding to the pressed-down key to the TV receiver 10. The remote controller RC outputs the instruction to the TV receiver 10 by utilizing infrared rays.

A menu key 201 serves to display/erase various menu screens through the display device 61.

A multi key 202 serves to display/erase a multi-screen through the display device 61.

An information key 203 serves to display/erase program related information about videos presented in the multi-screen.

An explanation key 204 serves to display/erase program explaining information for explaining contents of a selected one of videos presented in the multi-screen.

Respective numeric keys of “1” to “12” of a channel selecting key 205 serves to receive a specific channel. A specific one of the numeric keys in the channel selecting key 205 serves to directly change the number of video presenting regions on the multi-screen when the multi-screen is displayed. The specific channel or the number of video presenting regions in the multi-screen may be assigned to each numeric key.

A blue key 206, a red key 207, a green key 208 and a yellow key 209 which are color keys are assigned to be keys for directly changing the number of the video presenting regions in the multi-screen when a multi-screen display is performed.

A ground wave key 210 serves to select terrestrial digital broadcasting, a BS key 211 serves to select BS broadcasting, and a CS key 212 serves to select CS broadcasting. The keys are pressed down to cause a corresponding tuner and processing block to receive a program of the corresponding broadcast wave.

The direction key 213 serves to move a focus indicating that a specific one of the video presenting regions presented in the multi-screen is selected.

An enter key 214 serves to replace a specific one of the videos which is presented in the multi-screen and is selected with a video in a predetermined region of the multi-screen.

A return key 215 and an end key 216 serve to erase the multi-screen from the display device 61.

A channel up/down key 217 includes a channel up key for performing channel-up and a channel down key for performing channel-down to channel-up and channel-down in accordance with a channel number, among received or assigned channels.

The remote controller RC may be provided with a large number of other keys. Keys corresponding to the keys of the remote controller RC may be also disposed in the operation portion 51.

A user can operate the TV receiver 10 in order to perform plural operations, for example, a receipt of a specific channel program, a display/erasure of a multi-screen, a change in the number of video presenting regions in the multi-screen, a selection of a specific video in the multi-screen and a replacement of the specific video with a video in a predetermined region within the multi-screen, by pressing down the specific key of the remote controller RC.

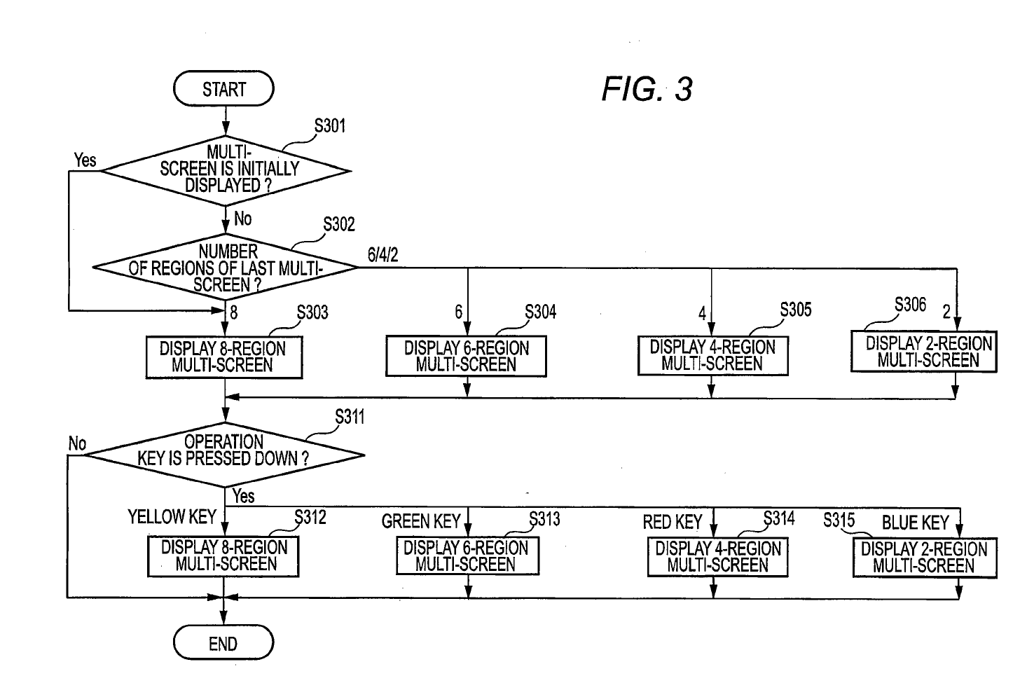

With reference to FIG. 3, next, description will be given to a processing for displaying the multi-screen and a processing for changing the number of the video presenting regions in the multi-screen.

FIG. 3 illustrates the example processing for displaying the multi-screen and for changing the number of the video presenting regions in the multi-screen.

The processing for displaying the multi-screen is started when the multi key 202 of the remote controller RC is pressed in a state where a specific program is being viewed. It is also possible to start the processing for displaying the multi-screen by selecting “multi-screen output” (not shown) which is an item for displaying the multi-screen in the menu screen output to the screen through press-down of the menu key 201 provided on the remote controller RC.

The processing for changing the number of the video presenting regions in the multi-screen is executed when the color key or a specific numeric key of the channel selecting key 205 is pressed in a state where the multi-screen is displayed.

First, when the multi key 202 provided on the remote controller RC is pressed down, it is decided whether the processing for displaying the multi-screen is executed for the first time or not (S301). If it is decided that the processing for displaying the multi-screen is executed for the first time (Yes in S301), a multi-screen having eight video presenting regions is displayed (S303).

On the other hand, if it is decided that the processing for displaying the multi-screen is not executed for the first time (No in S301), it is decided how many video display regions are displayed when the last processing for displaying the multi-screen is ended (S302). If the last processing for displaying the multi-screen is ended in a state where the multi-screen having the eight video display regions is displayed (8 in S302), the multi-screen having the eight video presenting regions is displayed (S303). If the last processing for displaying the multi-screen is ended in a state where a multi-screen having six video presenting regions is displayed (6 in S302), the multi-screen having the six video presenting regions is displayed (S304).

If the last processing for displaying the multi-screen is ended in a state where a multi-screen having four video presenting regions is displayed (4 in S302), similarly, the multi-screen having the four video presenting regions is displayed (S305). If the last processing for displaying the multi-screen is ended in a state where a multi-screen having two video presenting regions is displayed (2 in S302), the multi-screen having the two video presenting regions is displayed (S306).

More specifically, in the processing for displaying the multi-screen, a multi-screen having a predetermined number of video presenting regions is displayed depending on whether the display of the multi-screen is executed for the first time or the number of the video presenting regions in the last display of the multi-screen.

In a state where the multi screen having the predetermined number of video presenting regions is displayed, furthermore, it is decided which operation key provided on the remote controller RC is pressed down (S311). If the yellow key 209 is pressed down (Yes in S311 (yellow key)), the multi-screen having the eight video presenting regions is displayed (S312). If the green key 208 is pressed down (Yes in S311 (green key)), the multi-screen having the six video presenting regions is displayed (S313).

If the red key 207 is pressed down (Yes in S311 (red key)), similarly, the multi-screen having the four video presenting regions is displayed (S314). If the blue key 206 is pressed down (Yes in S311 (blue key)), the multi-screen having the two video presenting regions is displayed (S315). If it is decided that any of the operation keys is not pressed down (No in S311), a new multi-screen is not displayed.

When the multi key 202, the return key 215 or the end key 216 which is provided on the remote controller RC is pressed down in a state where the multi-screen having the predetermined number of video presenting regions is displayed, then, the processing for displaying the multi-screen is ended and the multi-screen is erased from the display device 61.

In other words, in the processing for changing the number of the video presenting regions in the multi-screen, a specific key which is provided on the remote controller RC and is caused to correspond to the number of the video presenting regions in the multi-screen is pressed down so that the number of the video presenting regions in the multi-screen can be changed directly.

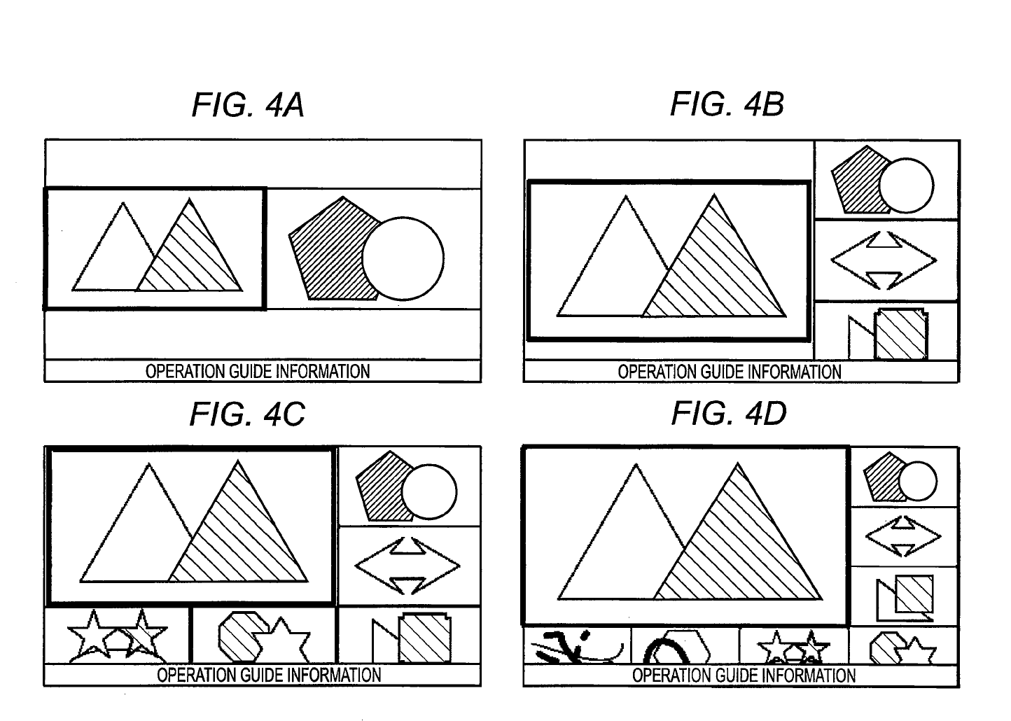

Next, a specific example of the multi-screen will be described with reference to FIGS. 4A to 4D. FIGS. 4A to 4D illustrate examples of the multi-screen.

FIG. 4A exemplarily illustrates the multi-screen having two video presenting regions, FIG. 4B exemplarily illustrates the multi-screen having four video presenting regions, FIG. 4C exemplarily illustrates the multi-screen having six video presenting regions, and FIG. 4D exemplarily illustrates the multi-screen having eight video presenting regions.

Given six videos in the multi-screen having the eight video presenting regions of FIG. 4D are presented in the multi-screen having the six video presenting regions of FIG. 4C. Similarly, given four videos in the multi-screen having the six video presenting regions of FIG. 4C are presented in the multi-screen having the four video presenting regions of FIG. 4B. Given two videos in the multi-screen having the four video presenting regions of FIG. 4B are presented in the multi-screen having the two video presenting regions of FIG. 4A.

Moreover, operation guide display regions for providing a guide for control of the multi-screen through the keys of the remote controller RC are disposed under the multi-screens shown in FIGS. 4A to 4D, respectively. The operation guide information indicates a correspondence of the specific key to the operation contents, for example, a presentation of the multi-screen having the two video presenting regions through the press-down of the blue key 206, a presentation of the multi-screen having the four video presenting regions through the press-down of the red key 207, a presentation of the multi-screen having the six video presenting regions through the press-down of the green key 208, and a presentation of the multi-screen having the eight video presenting regions through the press-down of the yellow key 209.

The operation guide display region may be displayed through a blending or may be superimposed and displayed to be a forefront surface. When the operation guide display region overlaps with the multi-screens shown in FIGS. 4B to 4D, the operation guide display region may be displayed through the α blending.

When a predetermined time passes after the multi-screens shown in FIGS. 4A to 4D are presented, the operation guide display regions are erased from the multi-screens. In the multi-screen having the two video presenting regions shown in FIG. 4A, a state where the operation guide display region is not erased but displayed may be continuously maintained even if the predetermined time passes after the multi-screen is presented. Thus, it is avoided to cause a non-display part of the video in the multi-screen.

In the multi-screens shown in FIGS. 4A to 4D, the video presenting region having a contour highlighted and focused is a main-video, which have been viewed on the display device 61 before the multi-screen is displayed. In FIGS. 4A to 4D, a video arranged and presented in the other video presenting region is a sub-video, which is corresponds to another channel other than that of the main-video. For example, the sub-video may be selected from a channel having an identical broadcast wave to the main-video (for example, if the main-video is of a terrestrial digital broadcast wave, the sub-video is also of the terrestrial digital broadcast wave).

For example, if the main-video corresponds to one channel of a terrestrial digital broadcast wave, the sub-video corresponds to the other channel of the terrestrial digital broadcast wave, if the main-video corresponds to one channel of a satellite digital broadcast wave, a sub-video corresponds to the other channel of the satellite digital broadcast wave. Although it depends on the number of provided tuners, the sub-video may be selected from the other kinds of broadcast wave or a video acquired from the external device IF portion 31. In the embodiment, eight tuners for the terrestrial digital broadcast wave are provided. Therefore, all of the sub-videos may be the terrestrial digital broadcast wave irrespective of the broadcast wave of the main-video.

Referring to the main-video on the multi-screen shown in each of FIGS. 4A to 4D, a video of a program having the same channel is presented even if the number of the video presenting regions in the multi-screen is changed through the press-down of the specific key of the remote controller RC. When the number of the video presenting regions is varied, there are presented a different number of sub-videos on the multi-screen shown in each of FIGS. 4A to 4D.

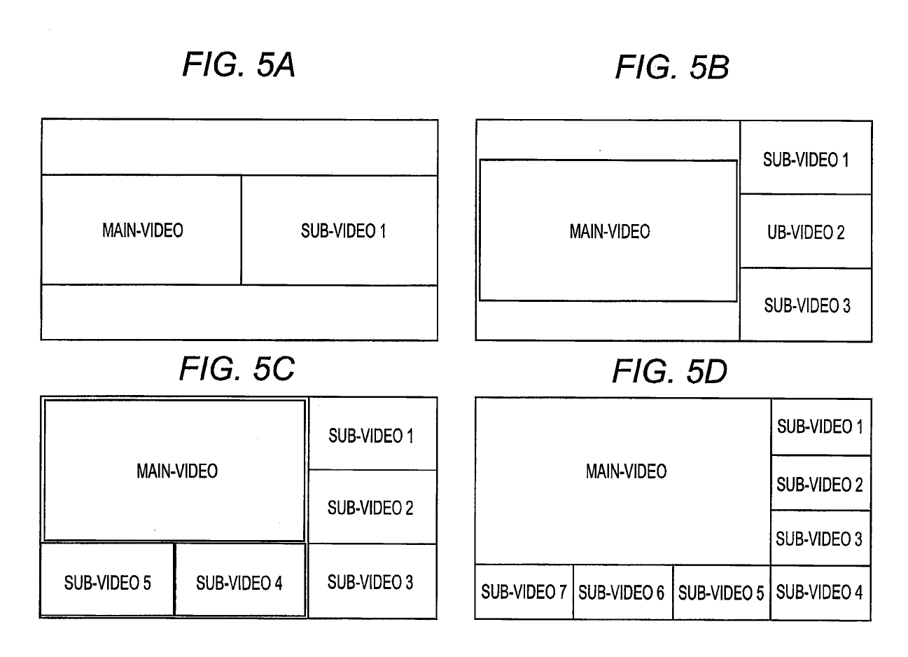

With reference to FIGS. 5A to 5D, next, description will be given to a specific example of the layout of the main-video and the sub-video in each of the multi-screens shown in FIGS. 4A to 4D.

FIGS. 5A to 5D illustrate the example layouts of the main-video and the sub-video in each of the multi-screens shown in FIGS. 4A to 4D.

FIG. 5A illustrates the example layout in the multi-screen having the two video presenting regions shown in FIG. 4A. FIG. 5B illustrates the example layout in the multi-screen having the four video presenting regions shown in FIG. 4B. FIG. 5C illustrates the example layout in the multi-screen having the six video presenting regions shown in FIG. 4C, and FIG. 5D illustrates the example layout in the multi-screen having the eight video presenting regions shown in FIG. 4D.

For each of the multi-screens in FIGS. 5A to 5D, the main-video is presented in a predetermined video presenting region. The main-video is presented in a left video presenting region in the multi-screen having the two video presenting regions, and is presented in a nearly-left-side larger-size video presenting region in the multi-screens having the four, six and eight video presenting regions.

That is, in the multi-screens having the four, six and eight video presenting regions, the main-video is presented in a larger size as compared with the sub-video. With the configuration, therefore, it is easy to identify the main-video.

Although the video presenting regions have various sizes for the main-video and the sub-video, the aspect ratio thereof are set to 16:9 to be equal to an aspect ratio of the display device 61 in each of the multi-screens shown in FIGS. 5A to 5D.

In the multi-screen having the six video presenting regions shown in FIG. 5C, moreover, a video presenting region of two sub-videos is adjacently arranged in each of a right portion in a vertical direction and a lower portion in a transverse direction over a contour of the video presenting region of the main-video. Furthermore, a single sub-video is also arranged in a diagonal part based on a right and lower portion of the video presenting region of the main-video. In the multi-screen having the eight video presenting regions shown in FIG. 5D, furthermore, a video presenting region of three sub-videos is adjacently arranged in each of a right portion in a vertical direction and a lower portion in a transverse direction over a contour of the video presenting region of the main-video. In addition, a single sub-video is also arranged in a diagonal part based on a right and lower portion of the video presenting region of the main-video.

By thus varying the sizes of the main-video and the sub-video with the video presenting regions of the main-video and the sub-video in the respective aspect ratios (16:9) reduced, accordingly, in a multi-screen, the sub-video can be displayed in a size which is as large as possible by effectively utilizing the whole video display region without a waste.

As shown in FIGS. 5A to 5D, a predetermined number of sub-videos are arranged and presented in a predetermined video presenting region in a given channel order. The order of the arrangement is not restricted to the specific examples shown in FIGS. 5A to 5D but may be arranged in a reverse order or an optionally-determined order.

The channel order may be set optionally through a menu screen (not shown) by a user, set based on a total viewing time measured by a functional block (not shown) for measuring the total viewing time for each channel in a past predetermined period, or set based on a history stored by a functional block (not shown) for storing a history of a channel related to a video output to the display device 61 before a present time.

Five high-order sub-videos in the multi-screen having the eight video presenting regions (one main-video and seven sub-videos) of FIG. 5D are presented as five of the six sub-videos in the multi-screen having the six video presenting regions of FIG. 5C.

Similarly, three high-order sub-videos in the multi-screen having the six video presenting regions (one main-video and five sub-videos) of FIG. 5C are presented as three of the four sub-videos in the multi-screen having the four video presenting regions of FIG. 5B.

Furthermore, a high-order one of three sub-videos presented in the multi-screen having the four video presenting regions (one main-video and three sub-videos) of FIG. 5B is presented as one sub-video in the multi-screen having the two video presenting regions of FIG. 5A.

When the number of the video presenting regions in the multi-screen is changed, the sub-video focused before the change may also be presented after the change.

The layout and number of the video presenting regions in the multi-screen is not restricted to that shown in FIGS. 5A to 5D. For example, the video presenting region of the main-video may have a larger area than that of the video presenting region of the sub-video in the multi-screen having the two video presenting regions, and furthermore, the main-video may be presented in the video presenting region on a right side toward the screen in each of the multi-screens having the two, four, six and eight video presenting regions.

In other words, in the case where each of the multi-screens having the two, four, six and eight video presenting regions is switched, the main-video is presented in a predetermined one of the video presenting regions in the respective multi-screens and a predetermined number of sub-videos are presented in the respective video presenting regions in a given channel order as shown in FIGS. 5A to 5D.

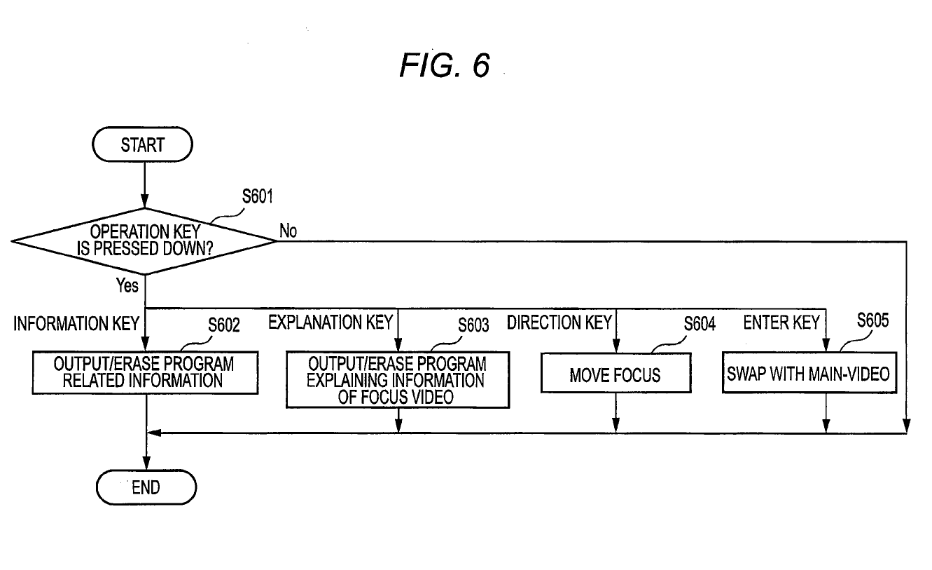

Next, plural processings for operating the multi-screen will be described with reference to FIG. 6. FIG. 6 illustrates the example processings for operating the multi-screen.

The processings for operating the multi-screen are executed through press-down of the information key 203, the explanation key 204, the direction key 213 of the enter key 214 which is provided on the remote controller RC by the user in a state where the multi-screen is displayed.

First of all, it is decided whether any of the operation keys provided on the remote controller RC is pressed down or not in the state where the multi-screen is displayed (S601). If the information key 203 is pressed down (Yes in S601 (information key)), an output/erasure of program related information which is related to a program presented in the multi-screen is alternately switched (S602). In other words, the program related information is erased in a state where the program related information is output, and the program related information is output in the reverse case.

If the explanation key 204 is pressed down (Yes in S601 (explanation key)), moreover, there is alternately switched an output/erasure of program explaining information for explaining contents of a program presented in a video presenting region which is focused (S603). In other words, the program explaining information is erased in a state where the program explaining information is output, and the program explaining information is output in the reverse case.

If the direction key 213 is pressed down (Yes in S601 (direction key)), a focus in the displayed multi-screen is moved depending on a direction of the direction key 213 pressed down (S604).

If the enter key 214 is pressed down (Yes in S601 (enter key)), the video presented in the focused video presenting region is replaced with the main-video (S605). In other words, the focused sub-video is presented as the new main-video in the corresponding video presenting region. The previous main-video is presented as the sub-video in the video presenting region of the focused sub-video. If the focused video presenting region serves to present the main-video, the videos are not replaced with each other.

If it is decided that any of the operation keys is not pressed down (No in S601), the processings are not executed. When the multi key 202, the return key 215 or the end key 216 is pressed down, then, the processing for displaying the multi-screen is ended so that the multi-screen is erased from the display device 61. Thereafter, the video in the video presenting region which is focused in the multi-screen is displayed over the whole screen.

As long as the multi key 202, the return key 215 or the end key 216 are not pressed down in the state where the multi-screen is displayed, the processings for operating the multi-screen are thus continued.

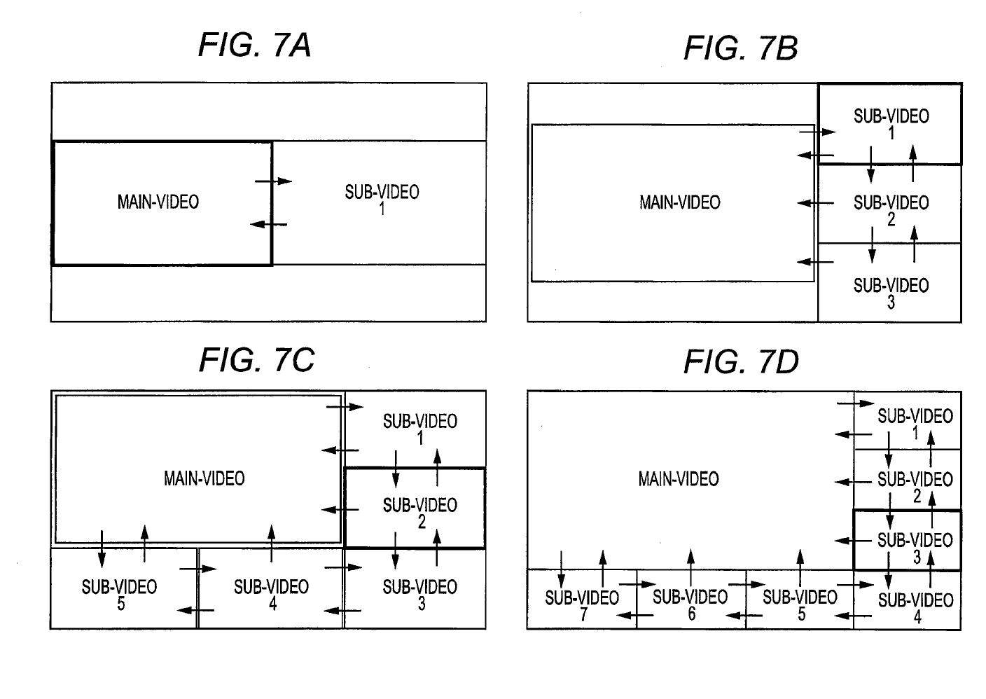

Next, a specific example of the focus movement in each of the multi-screens shown in FIGS. 4A to 4D will be described with reference to FIGS. 7A to 7D.

FIGS. 7A to 7D illustrate examples of a focus movement in each of the multi-screens shown in FIGS. 4A to 4D.

As in the flowchart shown in FIG. 6, the focus movement in the multi-screen is controlled through the press-down of the direction key 213 provided on the remote controller RC. Therefore, the focus is moved in four directions, that is, upward, downward, leftward and rightward directions.

More specifically, in the multi-screen having the two video presenting regions shown in FIG. 7A, when a rightward direction key of the direction key 213 is pressed down in a state where the video presenting region of the main-video is focused, the focus is moved to the video presenting region of a sub-video 1. When a leftward direction key of the direction key 213 is pressed down in a state where the video presenting region of the sub-video 1 is focused, the focus is moved to the video presenting region of the main-video.

Even if an upward direction key, a downward direction key or the leftward direction key of the direction key 213 is pressed down in the state where the video presenting region of the main-video is focused, the focus is not moved. Even if the upward direction key, the downward direction key or the rightward direction key of the direction key 213 is pressed down in the state where the video presenting region of the sub-video 1 is focused, moreover, the focus is not moved.

In the multi-screen having the four video presenting regions shown in FIG. 7B, furthermore, when the rightward direction key of the direction key 213 is pressed down in the state where the video presenting region of the main-video is focused, the focus is moved to the video presenting region of the sub-video 1. Even if the upward direction key, the downward direction key or the leftward direction key of the direction key 213 is pressed down in the state where the video presenting region of the main-video is focused, the focus is not moved.

When the leftward direction key of the direction key 213 is pressed down in the state where the video presenting region of the sub-video 1 is focused, moreover, the focus is moved to the video presenting region of the main-video. When the downward direction key of the direction key 213 is pressed down in the state where the video presenting region of the sub-video 1 is focused, furthermore, the focus is moved to the video presenting region of a sub-video 2. Even if the upward direction key or the rightward direction key of the direction key 213 is pressed down in the state where the video presenting region of the sub-video 1 is focused, the focus is not moved.

When the upward direction key of the direction key 213 is pressed down in the state where the video presenting region of the sub-video 2 is focused, the focus is moved to the video presenting region of the sub-video 1. When the downward direction key of the direction key 213 is pressed down, the focus is moved to the video presenting region of a sub-video 3. When the leftward direction key of the direction key 213 is pressed down in the state where the video presenting region of the sub-video 2 is focused, moreover, the focus is moved to the video presenting region of the main-video. Even if the rightward direction key of the direction key 213 is pressed down in the state where the video presenting region of the main-video is focused, however, the focus is not moved to the video presenting region of the sub-video 2 but is moved to the video presenting region of the sub-video 1 as described above. Even if the rightward direction key of the direction key 213 is pressed down in the state where the video presenting region of the sub-video 2 is focused, moreover, the focus is not moved.

When the leftward direction key of the direction key 213 is pressed down in the state where the video presenting region of the sub-video 3 is focused, furthermore, the focus is moved to the video presenting region of the main-video. Even if the rightward direction key of the direction key 213 is pressed down in the state where the video presenting region of the main-video is focused, however, the focus is not moved to the video presenting region of the sub-video 3 but is moved to the video presenting region of the sub-video 1 as described above. When the upward direction key of the direction key 213 is pressed down in the state where the video presenting region of the sub-video 3 is focused, moreover, the focus is moved to the video presenting region of the sub-video 2. Even if the downward direction key or the rightward direction key of the direction key 213 is pressed down in the state where the video presenting region of the sub-video 3 is focused, the focus is not moved.

In the multi-screen having the six video presenting regions shown in FIG. 7C and the multi-screen having the eight video presenting regions shown in FIG. 7D, furthermore, the focus is moved depending on the press-down of the specific direction key of the direction key 213 in a arrow direction as shown in the respective drawings, and the focus is not moved in a direction having no arrow.

In the case where the rightward direction key or the downward direction key in the direction key 213 is pressed down in the state where the video presenting region of the main-video is focused, the video presenting region to which the focus is moved is not restricted to the embodiment. For example, it is also possible to employ the following embodiment. More specifically, in the multi-screen having the four video presenting regions shown in FIG. 7B, when the rightward direction key of the direction key 213 is pressed down in the state where the video presenting region of the main-video is focused, the focus is moved to the video presenting region of the sub-video 2 or 3.

In other words, directions in which the focus movement corresponding to the direction key 213 is allowed are defined every video presenting region.

Furthermore, the respective multi-screens shown in FIGS. 7A to 7D are set into a state where the specific video presenting regions are focused, respectively. As in the flowchart shown in FIG. 6, the enter key 214 provided on the remote controller RC is pressed down so that the video presented in the focused video presenting region is replaced with the main-video.

More specifically, as in the multi-screen shown in FIG. 7B, when the enter key 214 is pressed down in a state where the video presenting region of the sub-video 1 is focused, the video presented as the sub-video 1 to the focused video presenting region is presented in the video presenting region of the main-video. Furthermore, the video presented, as the main-video, to the video presenting region of the main-video is presented, as the sub-video, to the video presenting region of the sub-video. When the video presented as the main-video is to be presented as the sub-video, the video is presented in the video presenting region of the sub-video 1 which is focused. When the video presented as the main-video is to be presented as the sub-video, moreover, the same video and the sub-videos presented at this time may be arranged again in an order for the channel set based on the predetermined condition.

As in the multi-screen shown in FIG. 7A, for example, even if the enter key 214 is pressed down in a state where the video presenting region of the main-video is focused, the main-video is not replaced.

In other words, it is possible to present, as the main-video, the sub-video presented in the video presenting region of the sub-video which is focused.

Furthermore, a sound corresponding to the video presented in the focused video presenting region is output from the speaker 62 with the movement of the focus.

More specifically, as in the multi-screen shown in FIG. 7B, a sound corresponding to the sub-video 1 is output from the speaker 62 in a state where the video presenting region of the sub-video 1 is focused.

In the embodiment, the sound corresponding to the video presented in the focused video presenting region is output from the speaker 62. A sound corresponding to the main-video may be output from the speaker 62 irrespective of the focused video, or a sound corresponding to the main-video may be output from the speaker 62 as one of right and left sounds while a sound corresponding to the focused video presenting region is output from the speaker 62 as the other of the right and left sounds at the same time.

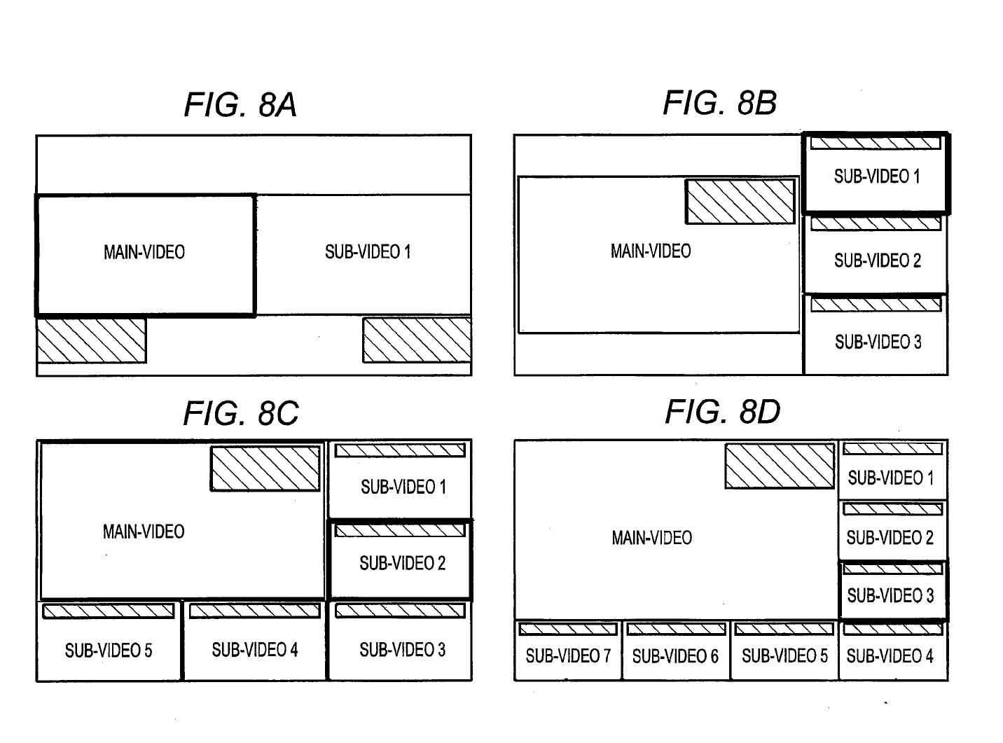

With reference to FIGS. 8A to 8D, next, description will be given to a specific example of the case where the program related information is output in each of the multi-screens shown in FIGS. 4A to 4D.

FIGS. 8A to 8D illustrate the example cases where the program related information is output in each of the multi-screens shown in FIGS. 4A to 4D.

As described above, the program related information includes a channel number, a broadcast wave, a name of a broadcasting station and a name of a program about the videos presented in the multi-screen and is also referred to as banner information.

More specifically, in a multi-screen having two video presenting regions shown in FIG. 8A, program related information about a program of a main-video is presented in a lower region shown in a slant line in the video presenting region of the main-video. Program related information about a program of a sub-video 1 is presented in a lower region shown in a slant line in the video presenting region of the sub-video 1.

In a multi-screen having four video presenting regions shown in FIG. 8B, moreover, program related information about a program of a main-video is presented in a region shown in a slant line and superimposed on the video presenting region of the main-video. The program related information about the program of the sub-video 1 is presented in a region shown in a slant line and superimposed on the video presenting region of the sub-video 1. Program related information about programs of sub-videos 2 and 3 are also presented in the same manner as the program related information about the program of the sub-video 1.

Also in a multi-screen having six video presenting regions shown in FIG. 8C and a multi-screen having eight video presenting regions shown in FIG. 8D, furthermore, program related information about programs of respective videos are presented in the same manner as the multi-screen having the four video presenting regions shown in FIG. 8B.

Although the program related information is erased from the multi-screen when a predetermined time passes after each of the multi-screens shown in FIGS. 8A to 8D is presented, it may be presented until the erasure to meet a demand for the erasure. Although there is presented the program related information about the program of all of the videos, that is, the main-video and the sub-videos which are presented in the multi-screen in the embodiment, it is also possible to present only the program related information about the program of the video presented in the focused video presenting region or the main-video. Switching to present the program related information about all of the videos or to present only the program related information about the focused video or the main-video is performed by an operation through the predetermined key of the remote controller RC.

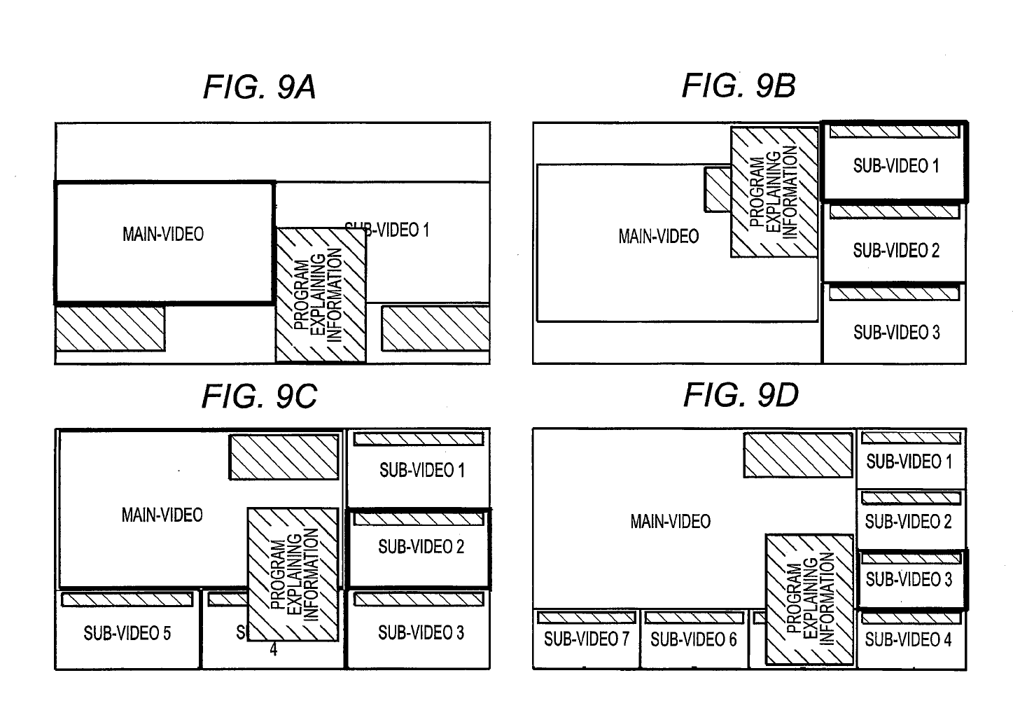

With reference to FIGS. 9A to 9D, next, description will be given to a specific example of the case where program explaining information is output in each of the multi-screens shown in FIGS. 4A to 4D.

FIGS. 9A to 9D illustrate the example cases where the program explaining information is output in each of the multi-screens shown in FIGS. 4A to 4D.

As described above, the program explaining information serves to explain, in detail, contents of a program of any of videos which is presented in the multi-screen and is placed in the focused video presenting region. The program explaining information includes information about a summary, a performer, a broadcasting time and a genre in a program which is being broadcast and is also a part of the program related information.

More specifically, in a multi-screen having two video presenting regions shown in FIG. 9A, there is set a state where a video presenting region of a main-video is focused, and the program explaining information about a program of the main-video is presented in a region shown in shading in the vicinity of the video presenting region of the main-video.

In a multi-screen having four video presenting regions shown in FIG. 9B, moreover, there is set a state where a video presenting region of a sub-video 1 is focused, and the program explaining information about a program of the sub-video 1 is presented in a region shown in shading in the vicinity of the video presenting region of the sub-video 1.

In a multi-screen having six video presenting regions shown in FIG. 9C and a multi-screen having eight video presenting regions shown in FIG. 9D, furthermore, program related information about a program of a video presented in the video presenting region which is focused over each of the multi-screens is presented in the vicinity of each focused video presenting region in the same manner as the multi-screen having the two video presenting regions shown in FIG. 9A and the multi-screen having the four video presenting regions shown in FIG. 9B.

Although the program explaining information is erased from the multi-screen when a predetermined time passes after each of the multi-screens shown in FIGS. 9A to 9D is presented, it may be presented until the erasure to meet a demand for the erasure. Although there is presented only the program explaining information about the program of the video presented in the video presenting region which is focused over the multi-screen in the embodiment, it is also possible to employ an embodiment in which there is presented program explaining information about a program of all of the videos including the main-video and the sub-videos which are presented in the multi-screen or the main-video. Switching to present only the program explaining information about the focused video or to present the program explaining information about all of the videos or the main-video is performed by an operation through the predetermined key of the remote controller RC.

As described above, according to the embodiment, it is possible to easily switch the multi-screens having different number of regions of the video through the operation key provided on the remote controller RC, and furthermore, it is possible to perform various operations over the respective multi-screens. Therefore, plural program videos can be conveniently and output with a high operability.

The invention is not restricted to the embodiment but various changes and modifications can be made without departing from the scope of the invention.

According to an aspect of the embodiments, there is provided a video output apparatus capable of allowing the user to conveniently output plural program videos with a high operability.

What is claimed is:

1. A video output apparatus comprising:
a receiving module configured to receive a plurality of video signals being different from one another;
a video output module configured to output a multi-video screen in which a plurality of video presentation regions defined by dividing a screen with a given number are arranged on the same screen, the video presentation regions being displayed with videos corresponding to the received video signals; and
a controller configured to control the video output module to output, upon receiving an instruction indicating the number of the video presentation regions to be displayed in the multi-video screen, an updated multi-video screen having the instructed number of the video presentation regions in a state where the multi-video screen is output.

2. The apparatus of claim 1,
wherein the number of the video presentation regions in the multi-video screen is equal to or greater than two and is equal to or smaller than eight.

3. The apparatus of claim 2,
wherein a main-video and a sub-video are respectively layouted on specific video presentation regions in the multi-video screen in accordance with a given condition, the main-video corresponding to a program of a specific channel being previously output before the multi-video screen is output, the sub-video corresponding to a program of the other channel,

4. The apparatus of claim 3,
wherein the given condition includes:
an order optionally set by a user;
an order set based on a total viewing time for each channels within a given period from a present time; or
an order set based on a history of the channel being previously output.

5. The apparatus of claim 3,
wherein the sub-video is selected among programs provided in the same broadcast wave as the main-video.

6. The apparatus of claim 3,
wherein the video output module permits a user to select a specific one of the main-video and the sub-video, so that, when the sub-video is selected, the sub-video is layouted to be replaced with the main-video.

7. The apparatus of claim 3,
wherein the video output module permits a user to select a specific one of the main-video and the sub-video, so that, when the sub-video is selected, the sound corresponding to the main-video and/or the sound corresponding to the selected sub-video is output.

8. The apparatus of claim 3,
wherein the video output module permits a user to select a specific one of the main-video and the sub-video, so that program related information about the selected video and/or the output video is output.

9. A video output apparatus comprising:
a receiving module configured to receive a plurality of video signals being different from one another; and
a video output module configured to output a multi-video screen in which a plurality of video presentation regions defined by dividing a screen with a given number are arranged on the same screen on which videos corresponding to the received video signals are presented,
wherein the multi-video screen includes:
a main-video presentation region on which a main-video corresponding to a program of a specific channel being previously output before the multi-video screen is output is presented; and
a plurality of sub-video presentation regions on which sub-videos corresponding to programs of the other channels are presented,
wherein the main-video presentation region and the sub-video presentation regions have the same aspect ratio,
wherein the main-video presentation region is larger than each of the sub-video presentation regions, and
wherein the sub-video presentation regions are arranged along a contour of the main-video presentation region so that the number thereof in a vertical direction and the number thereof in a horizontal direction are the same.

10. The apparatus of claim 9,
wherein the video output module permits a user to select a specific one of the main-video and the sub-videos, so that program related information about the selected video and/or the output video is output.

11. A video output method comprising:
receiving a plurality of video signals being different from one another;
outputting a multi-video screen in which a plurality of video presentation regions defined by dividing a screen with a given number are arranged on the same screen, the video presentation regions being displayed with videos corresponding to the received video signals; and
outputting, upon receiving an instruction indicating the number of the video presentation regions to be displayed in the multi-video screen, an updated multi-video screen having the instructed number of the video presentation regions in a state where the multi-video screen is output.
